(19) United States
(12) Patent Application Publication
(10) Pub. No.: US 2003/0146203 A1
(43) Pub. Date: Aug. 7, 2003

(54) Baking oven with door sliding in the guide groove

(76) Inventor: Donglei Wang, Nanping Town (CN)

Correspondence Address: Judson K. Champlin, WESTMAN CHAMPLIN & KELLY, Suite 1600-International Centre, 900 South Second Avenue, Minneapolis, MN, 55402-3319, US

(21) Appl. No.: 10/345,786

(22) Filed: Jan. 16, 2003

(30) Foreign Application Priority Data
Feb. 7, 2002 (CN) 02225811.6

(51) Int. Cl. F27D 11/00

(52) U.S. Cl. 219/411

(57) ABSTRACT

A baking oven with a door sliding along a guide groove includes an arcuate housing, an electrical heating tube and a baking tray. A guide groove is provided on the left side plate and the right side plate attached to the housing and extends throughout the arcuate circumference of the side plates. The door has an arcuate shape and the two edges of the door are attached to the guide groove. The baking oven of the present invention is opened by sliding of the door other than the rotation of the door in the conventional one. A guide groove is provided on the two sides of the oven body, and the arcuate door slides along the guide groove toward the back direction and upward direction so as to be opened. The door is opened and closed by the gravity of itself. When the door is contaminated, the user may release the limit means and then the glass door slides out along the guide groove so as to be conveniently cleaned.

### BACKGROUND OF THE INVENTION

1. Field of the Invention

The present invention relates to a baking oven, more particularly, to a baking oven with a door sliding in a guide groove so as to be opened.

2. The Technical Background

In a conventional baking oven, the door of the electrical baking oven is generally opened by it's rotation around the center of the axis of the door. More specifically, a hinge shaft is mounted to the case or the glass door. When the door is to be opened, the door rotates about the shaft as the central axis. This conventional type of door is advantageous in its simple configuration. But this type of door is proven to be problematic in the following aspects. Firstly, sufficient space is required to open the door. Moreover, when the door is opened, sway or tilt may occur in the baking oven due to the variation of the center of gravity and inertia. Further, the hinge shaft and the seat should be made of materials that have desirable rigidity, strength and wearing quality. In addition, it is desirable to fit a limit mechanism to the baking oven so as to prevent the door from automatically releasing from the baking oven or being automatically opened.

### SUMMARY OF THE INVENTION

The present invention is made to overcome the above problems and disadvantages of the conventional door of the baking oven. It is an object of the present invention to provide a baking oven with a door sliding in a guide groove so as to be opened.

The foregoing and other objects of the present invention are achieved by providing a baking oven including an arcuate housing; an electrical heating tube; a baking tray; a left side plate; a right side plate; a door and a limit means. The left side plate and the right side plate are attached to the arcuate housing. A guide groove is provided on the arcuate circumference of the left side plate and the right side plate, and the two edges of the arcuate shape door are attached to the guide groove.

The limit means is provided on the front or the back of the housing and comprises a limit rod and a spring gasket. The limit means is inserted into the recess of the closed guide groove.

Contrary to the conventional the baking oven which is opened by rotating of the door, the baking oven of the present invention is opened by sliding of the door. A guide groove is provided on the two sides of the oven body, and the arcuate door slides along the guide groove toward the back direction and upward direction so as to be opened. The door is opened and closed by the gravity of itself. When the door is contaminated, the user may release the limit means and then the glass door slides out along the guide groove so as to be conveniently cleaned. The baking oven of the present invention has many advantages and features. Firstly, it is not necessary to provide special space to the door when it is opened. Secondly, as the door is opened and closed steadily and the center of gravity does not vary greatly, there is no occurrence of tilt and upset of the baking oven. This is a very important feature and advantage of the small-sized and the medium-sized electrical appliances. Moreover, the gravity of the door is evenly supported by the guide groove disposed on the two sides, there is no problem of stress concentration and magnitude of torque. Furthermore, the glass door is opened and closed by the gravity of itself, so no additional mechanism is required, thus reducing the number of the components. In addition, the baking oven of the present invention has simple configuration and it is highly convenient to be cleaned.

### BRIEF DESCRIPTION OF THE DRAWINGS

The above and other objects and disadvantages of the invention will become apparent and readily appreciated from the following description of the preferred embodiments, taken in conjunction with the accompanying drawings of which:

FIG. 1 is a schematic view of the baking oven according to an embodiment of the present invention;

FIG. 2 is a view taken along the line A-A of the FIG. 1; and

FIG. 3 is an enlarged view showing the part B of the FIG. 1.

### DETAILED DESCRIPTION OF THE PREFERRED EMBODIMENTS

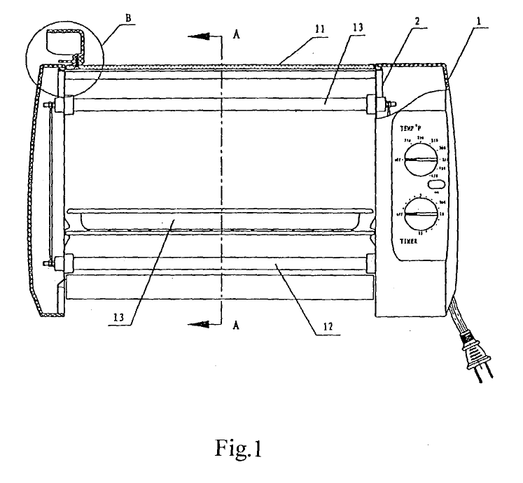

As shown in FIGS. 1,2 and 3, a U-shape guide groove 10 is arranged on the circumference of a left side plate 8 and a right side plate 2. A door 6 is made of glass and the two sides of the door are covered with a metal fitting strip 7. One folded side of the fitting strip 7 extends into the guide groove 10. The glass door is configured such that the door is opened/closed when the fitting strip 7 at the left side and the right side slides along the guide groove 10 of the left side plate 8 and the right side plate 2. When the glass door 6 is contaminated and a cleaning operation is carried out, the user opens the limit rod 3 below the spring gasket 4. Then, the glass door can slide out from the back and lower side of the oven body along the guide groove. After the cleaning operation is completed, the glass door is inserted back into its original position and the limit rod 3 is reset to the closed position.

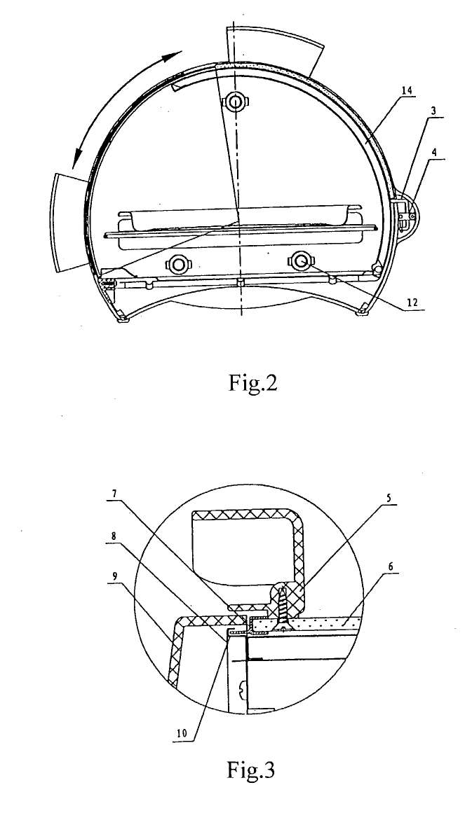

FIGS. 1,2 and 3 show a baking oven according to an embodiment of the present invention. As shown in the FIGS. 1-3, a baking oven includes an arcuate housing 11, an electrical heating tube 12, a baking tray 8, a left side plate 8, a right side plate 2, a door 6, a halogen tube 13 and a back board 14. The guide groove 10 is formed on the arcuate left side plate 8 and right side plate 2 and extends throughout the complete arcuate circumference of the left side plate 8 and right side plate 2. The door 6 has an arcuate shape and is attached to the guide groove 10 at the two edges of the door 6. A handle 5 is mounted on the door 6. A limit rod 3 and a spring gasket are provided at the back side of the housing 11. The limit rod 3 is secured by the spring gasket and is inserted into the recess of closed guide groove 10. The arcuate door 6 is sealed so as to prevent the light from leaking out from the interior of the baking oven.

Although a few preferred embodiments have been shown and described, it would be appreciated by those skilled in the art that changes may be made in these embodiments without departing from the principles and spirit of the invention, the scope of the which is defined in the claims and their equivalents.

1. A baking oven, comprising:
an arcuate housing; an electrical heating tube; a baking tray; a door; a left side plate; a right side plate and a limit means;
wherein a guide groove being provided on said left side plate and said right side plate attached to said housing and extending throughout the arcuate circumference of said side plates; and
said door having an arcuate shape and the two edges of said door being attached to said guide groove.

2. The baking oven according to claim 1, wherein the two edges are inserted into said guide groove.

3. The baking oven according to claim 1, wherein a limit means is arranged in the front side or the back side of said housing and is inserted into a recess of the closed guide groove.

4. The baking oven according to claim 1, wherein a handle is provided on said door.
